(19) United States
(12) Patent Application Publication
(10) Pub. No.: US 2016/0140898 A1
(43) Pub. Date: May 19, 2016

(54) ORGANIC LIGHT-EMITTING DISPLAY DEVICE AND METHOD OF DRIVING THE SAME

(71) Applicant: SAMSUNG DISPLAY CO., LTD., Yongin-City (KR)

(72) Inventors: Chang Ho Hyun, Seoul (KR); Sung Jin Kang, Cheonan-si (KR)

(21) Appl. No.: 14/677,812

(22) Filed: Apr. 2, 2015

(30) Foreign Application Priority Data
Nov. 18, 2014 (KR) 10-2014-0161075

(51) Int. Cl. G09G 3/32

(52) U.S. Cl. CPC G09G 3/3233; G09G 3/3283; G09G 2320/045; G09G 2320/0257; G09G 2310/08; G09G 2310/0272; G09G 2310/027; G09G 2320/0295; G09G 2300/0413

(57) ABSTRACT

An organic light-emitting display device including a data driver configured to generate a data signal based on image data provided by a timing controller and to provide the data signal to a plurality of data lines, a display panel including a pixel unit, which controls an amount of current flowing from a first power source to a second power source according to the data signal provided thereto via the plurality of data lines, and a dummy pixel unit, which has a plurality of dummy pixel circuits that are configured to receive the data signal via the plurality of data lines and a compensation signal generator configured to generate a compensation signal by comparing an amount of current flowing in the pixel unit and an amount of current flowing in the dummy pixel unit.

### CROSS-REFERENCE TO RELATED APPLICATION

This application claims priority to and the benefit of Korean Patent Application No. 10-2014-0161075 filed on Nov. 18, 2014 in the Korean Intellectual Property Office, the disclosure of which is incorporated herein by reference in its entirety.

### BACKGROUND

1. Field

The invention relates to an organic light-emitting display device and a method of driving the same.

2. Description of the Related Art

Organic light-emitting display devices, which have been increasingly highlighted as next-generation display devices, display an image by using organic light-emitting diodes (OLEDs), which generate light through the recombination of electrons and holes. Organic light-emitting display devices provide various benefits, such as fast response speed, high luminance, wide viewing angles and low power consumption.

More specifically, an organic light-emitting display device uses a driving transistor included in each pixel to control the amount of current provided to each OLED, and each OLED generates light with a predetermined luminance level based on the amount of current provided thereto.

OLEDs deteriorate over time in proportion with the amount of time of use thereof, thereby lowering display luminance and causing image sticking. Because OLEDs used to display bright images may deteriorate more severely than OLEDs used to display dark images, the level of deterioration of OLEDs in a display panel may differ from one area to another area in the display panel.

Accordingly, a technique has been suggested in which a monitoring transistor is added to each pixel to read out driving information relating to a driving transistor and to compensate for a data voltage to be applied to each pixel based on the read-out driving information.

However, such structure having a monitoring transistor added to each pixel may be susceptible to noise and a decrease in aperture ratio.

### SUMMARY

Example embodiments of the invention provide an organic light-emitting display device, which is capable of improving the deterioration of organic light-emitting diodes (OLEDs) and the occurrence of image sticking.

Example embodiments of the invention also provide a method of driving an organic light-emitting display device, which is capable of improving the deterioration of OLEDs and the occurrence of image sticking.

However, example embodiments of the invention are not limited to those set forth herein. The above and other example embodiments of the invention will become more apparent to one of ordinary skill in the art to which the invention pertains by referencing the detailed description of the invention given below.

According to an example embodiment of the invention, an organic light-emitting display device is described, the device including: a data driver configured to generate a data signal based on image data provided by a timing controller and to provide the data signal to a plurality of data lines; a display panel including: a pixel unit configured to control an amount of current flowing from a first power source to a second power source according to the data signal provided thereto via the plurality of data lines; and a dummy pixel unit including a plurality of dummy pixel circuits configured to receive the data signal via the plurality of data lines; and a compensation signal generator configured to generate a compensation signal by comparing an amount of current flowing in the pixel unit and an amount of current flowing in the dummy pixel unit.

The timing controller may be configured to receive the compensation signal from the compensation signal generator and to correct the image data based on the compensation signal.

The compensation signal generator may include: a first digital signal generator configured to measure an amount of current flowing from the pixel unit to the second power source and to convert a voltage corresponding to the amount of current measured by the first digital signal generator into a first digital signal; a second digital signal generator configured to measure an amount of current flowing from the dummy pixel unit to the second power source and to convert a voltage corresponding to the amount of current measured by the second digital signal generator into a second digital signal; a memory configured to store the first digital signal and the second digital signal provided by the first digital signal generator and the second digital signal generator; and an operation unit configured to generate the compensation signal by comparing the first digital signal and the second digital signal stored in the memory.

The first digital signal generator may include: a first current detector configured to measure the amount of current flowing from the pixel unit to the second power source; a first amplifier configured to amplify a voltage corresponding to the amount of current measured by the first current detector; and a first analog-to-digital converter (ADC) configured to convert the amplified voltage provided by the first amplifier into a digital signal.

The second digital signal generator may include: a second current detector configured to measure the amount of current flowing from the dummy pixel unit to the second power source; a second amplifier configured to amplify a voltage corresponding to the amount of current measured by the second current detector; and a second ADC configured to convert the amplified voltage provided by the second amplifier into a digital signal.

The first digital signal generator may include: a third current detector configured to measure an amount of current flowing from the first power source to the pixel unit; a third amplifier configured to amplify a voltage corresponding to the amount of current measured by the third current detector; and a third ADC configured to convert the amplified voltage provided by the third amplifier into a digital signal.

The second digital signal generator may include: a fourth current detector configured to measure an amount of current flowing from the first power source to the dummy pixel unit; a fourth amplifier configured to amplify a voltage corresponding to the amount of current measured by the fourth current detector; and a fourth ADC configured to convert the amplified voltage provided by the fourth amplifier into a digital signal.

The operation unit may be configured to divide the pixel unit into a plurality of groups each having a predefined number of pixel circuits, to calculate a first average value by averaging current values of one or more pixel circuits included in each of the groups, to calculate a second average value by averaging current values of the plurality of dummy pixel circuits, and to generate the compensation signal by using the first average value and the second average value.

According to another example embodiment of the present invention, an organic light-emitting display device is described, including: a pixel unit including a first driving transistor, the first driving transistor including a first terminal connected to a first power source and a second terminal connected to a second power source via an organic light-emitting diode (OLED); a dummy pixel unit including a second driving transistor, the second driving transistor including a first terminal connected to the first power source and a second terminal connected to the second power source; and a compensation signal generator connected to the pixel unit and the dummy pixel unit and configured to generate a compensation signal by measuring an amount of current flowing in the pixel unit and an amount of current flowing in the dummy pixel unit and to perform an operation on the measured amounts of current.

The organic light-emitting display device may further include: a data driver connected to the pixel unit and the dummy pixel unit via a data line; and a timing controller configured to receive the compensation signal from the compensation signal generator, correct image data based on the compensation signal, and provide a corrected image data to the data driving unit.

The organic light-emitting display device may further include: a scan driver connected to the pixel unit and the dummy pixel unit via a scan line, wherein the timing controller is configured to provide a driving control signal to the scan driving unit during a driving period and to provide a sensing control signal to the scan driving unit during a sensing period.

The pixel unit may further include: a first switching transistor including a first terminal connected to the data line and a second terminal connected to a control terminal of the first driving transistor; and a first capacitor having a first terminal connected to the first terminal of the first driving transistor and a second terminal connected to the second terminal of the first switching transistor.

The dummy pixel unit may further include: a second switching transistor having a first terminal connected to the data line and a second terminal connected to a control terminal of the second driving transistor; and a second capacitor having a first terminal connected to the first terminal of the second driving transistor and a second terminal connected to the second terminal of the second switching transistor.

The compensation signal generator may include: a first current detector between the pixel unit and one of the first power source and the second power source; a first amplifier connected to the first current detector and is configured to amplify a voltage applied to the first current detector; a first ADC configured to convert the amplified voltage provided by the first amplifier into a digital signal; a second current detector between the dummy pixel unit and one of the first power source and the second power source; a second amplifier configured to amplify a voltage applied to the second current detector; a second ADC configured to convert the amplified voltage provided by the second amplifier into a digital signal; a memory configured to store the digital signal provided by the first ADC and the digital signal provided by the second ADC; and an operation portion configured to generate the compensation signal by performing a comparison operation of the digital signals stored in the memory.

The operation portion may be configured to: divide the pixel unit into a plurality of groups each having a predefined number of pixel circuits; calculate a first average value by averaging current values of one or more pixel circuits included in each of the groups; calculate a second average value by averaging current values of a plurality of dummy pixel circuits; and generate the compensation signal based on the first average value and the second average value.

According to another example embodiment of the present invention, a method of driving an organic light-emitting display device is described, the method including: measuring an amount of current flowing in a pixel unit and an amount of current flowing in a dummy pixel unit; generating a compensation signal by performing a comparison operation on the measured amounts of current; correcting image data based on the compensation signal; and providing a data signal corresponding to the corrected image data to the pixel unit.

The measuring may include: measuring the amount of current flowing in the pixel unit; amplifying a voltage corresponding to the measured amount of current flowing in the pixel unit; and converting the amplified voltage into a digital signal.

The measuring may include: measuring the amount of current flowing in the dummy pixel unit; amplifying a voltage corresponding to the measured amount of current flowing in the dummy pixel unit; and converting the amplified voltage into a digital signal.

The generating include: dividing the pixel unit into a plurality of groups each having a predefined number of pixel circuits; and calculating a first average value by averaging current values of one or more pixel circuits included in each of the groups.

The generating may further include: calculating a second average value by averaging current values of a plurality of dummy pixel circuits; and generating the compensation signal based on the first average value and the second average value.

According to the example embodiments, it may be possible to measure a driving current without a requirement of an additional monitoring transistor and thus to compensate for a decrease in luminance. Also, because no additional monitoring transistor is needed, it is possible to improve an aperture ratio and noise.

In addition, because a decrease in luminance can be compensated for by using dummy pixels, it may be possible to reduce the variation of the properties of an OLED according to changes in the surroundings.

Moreover, because a current can be measured by dividing a pixel unit into a number of groups, it may be possible to reduce the size of a memory.

Other features and example embodiments will be apparent from the following detailed description, the drawings, and the claims.

### BRIEF DESCRIPTION OF THE DRAWINGS

The above and other features and aspects of the present invention will become more apparent by describing in detail, the embodiments thereof with reference to the attached drawings in which:

FIG. 1 is a block diagram of an organic light-emitting display device according to an example embodiment of the invention.

FIG. 2A is a circuit diagram of a pixel according to an example embodiment of the invention.

FIG. 2B is a circuit diagram of a dummy pixel according to an example embodiment of the invention.

FIG. 3 is a block diagram of a compensation signal generation unit according to the example embodiment of FIG. 1.

FIG. 4 is a circuit diagram of the compensation signal generation unit illustrated in FIG. 3.

FIG. 5 is a block diagram of an organic light-emitting display device according to another example embodiment of the invention.

FIG. 6 is a block diagram of a compensation signal generation unit according to the example embodiment of FIG. 5.

FIG. 7 is a circuit diagram of the compensation signal generation unit illustrated in FIG. 6.

FIG. 8 is a schematic diagram illustrating the generation of a compensation signal by the compensation signal generation unit of FIG. 4, according to an example embodiment of the invention.

FIG. 9 is a flowchart illustrating a method of driving an organic light-emitting display device, according to an example embodiment of the invention.

FIG. 10 is a flowchart illustrating the generation of a compensation signal as performed in the method according to the example embodiment of FIG. 9.

### DETAILED DESCRIPTION OF THE EMBODIMENTS

Aspects and features of the present invention and methods of accomplishing the same may be understood more readily by reference to the following detailed description of example embodiments and the accompanying drawings. The present invention may, however, be embodied in many different forms and should not be construed as being limited to the embodiments set forth herein. Rather, these embodiments are provided so that this disclosure will be more thorough and more complete and will more fully convey the concept of the invention to those skilled in the art, and the present invention will be defined by the appended claims and their equivalents. Like reference numerals refer to like elements throughout the specification.

The terminology used herein is for the purpose of describing particular embodiments and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being “on”, “connected to” or “coupled to” another element or layer, it can be directly on, connected to or coupled to the other element or layer or intervening elements or layers may be present. In contrast, when an element is referred to as being “directly on”, “directly connected to” or “directly coupled to” another element or layer, there are no intervening elements or layers present. As used herein, the term “and/or” includes any and all combinations of one or more of the associated listed items.

It will be understood that, although the terms first, second, etc., may be used herein to describe various elements, components, regions, layers and/or sections, these elements, components, regions, layers and/or sections should not be limited by these terms. These terms are only used to distinguish one element, component, region, layer, or section from another region, layer, or section. Thus, a first element, component, region, layer, or section discussed below could be termed a second element, component, region, layer, or section without departing from the teachings of the present invention.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, for example, the term “below” can encompass both an orientation of above and below. The device may be otherwise oriented (e.g., rotated 90 degrees or at other orientations) and the spatially relative descriptors used herein may be interpreted accordingly.

Embodiments are described herein with reference to cross-sectional illustrations that are schematic illustrations of example embodiments (and intermediate structures). As such, variations of the shapes of the illustrations as a result of, for example, manufacturing techniques and/or tolerances, are to be expected. Thus, these embodiments should not be construed as being limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from an implanted to a non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as the terms commonly understood by one of ordinary skill in the art to which the present invention belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

The organic light-emitting display device and/or any other relevant devices or components according to embodiments of the present invention described herein may be implemented utilizing any suitable hardware, firmware (e.g. an application-specific integrated circuit), software, or a suitable combination of software, firmware, and hardware. For example, the various components of the organic light-emitting display device may be formed on one integrated circuit (IC) chip or on separate IC chips. Further, the various components of the organic light-emitting display device may be implemented on a flexible printed circuit film, a tape carrier package (TCP), a printed circuit board (PCB), or formed on a same substrate as the [device]. Further, the various components of the organic light-emitting display device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the exemplary embodiments of the present invention.

Hereinafter, embodiments of the present invention will be described with reference to the accompanying drawings.

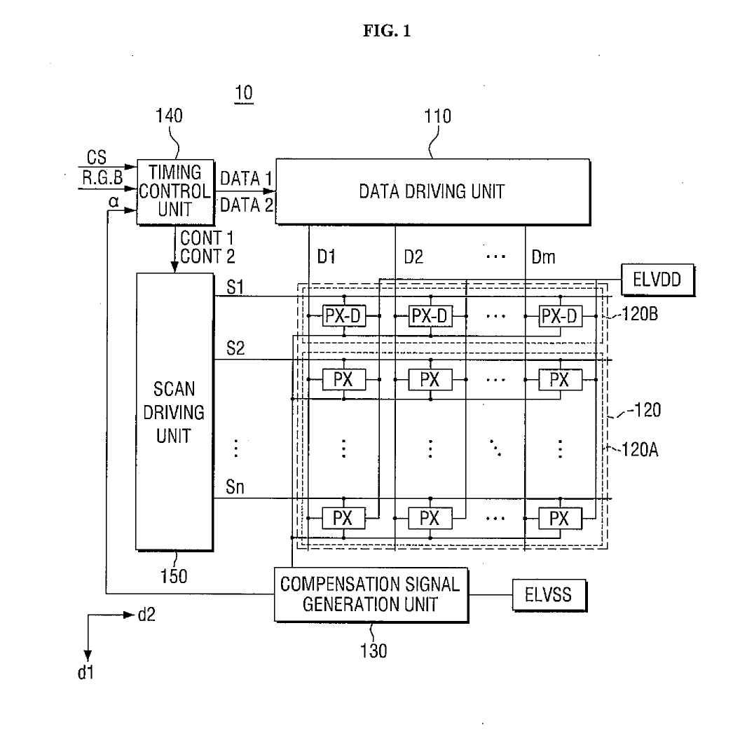

FIG. 1 is a block diagram of an organic light-emitting display device according to an example embodiment of the invention.

Referring to FIG. 1, an organic light-emitting display device may include a data driving unit 110 (or data driver), a display panel 120, and a compensation signal generation unit 130 (or compensation signal generator). The organic light-emitting display device may also include a timing control unit 140 (or timing controller) and a scan driving unit 150 (or scan driver).

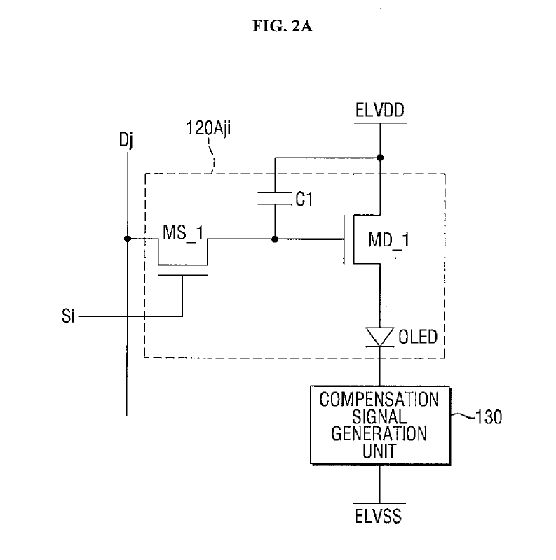

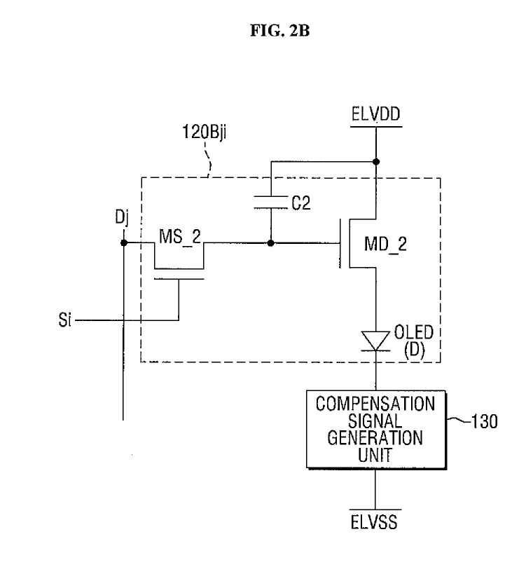

The data driving unit 110 may be connected to the display panel 120 via a plurality of data lines D1 through Dm. The data driving unit 110 may provide a data signal via the data lines D1 through Dm under the control of the timing control unit 140. More specifically, the data driving unit 110 may provide a data signal to a pixel PX or a dummy pixel PX_D selected by a scan signal. Each of a plurality of pixels PX of the display panel 120 may emit light in response to a data signal being applied thereto, and may thus display an image. A plurality of dummy pixels PX_D of the display panel 120 may have the same structure as the plurality of pixels PX. The organic light-emitting display device may determine the degree of deterioration of a plurality of organic light-emitting diodes (OLEDs) included in the plurality of pixels PX, respectively, by performing a comparison operation on the amount of current flowing in the plurality of dummy pixels PX_D with the amount of current flowing in the plurality of pixels PX. That is, by comparing the amount of current flowing in the plurality of dummy pixels PX_D with the amount of current flowing in the plurality of pixels PX. The plurality of dummy pixels PX_D will be described later in further detail with reference to FIG. 2B.

The display panel 120 may be a region where an image is displayed. The display panel 120 may include the data lines D1 through Dm (where m is a natural number greater than 1) and a plurality of scan lines S1 through Sn (where n is a natural number greater than 1). The display panel 120 may also include a pixel unit 120A, which has the plurality of pixels PX that are provided at the intersections between the data lines D1 through Dm and the scan lines S1 through Sn, and a dummy pixel unit 120B, which includes the plurality of dummy pixels PX_D which are located in a different area from the pixel unit 120A. The data lines D1 through Dm, the scan lines S1 through Sn, the pixel unit 120A and the dummy pixel unit 120B may be located on a single substrate, and the data lines D1 through Dm and the scan lines S1 through Sn may be insulated from one another.

The data lines D1 through Dm may extend in a first direction d1, and the scan lines S1 through Sn may extend in a second direction d2, which intersects the first direction d1. In the example embodiment of FIG. 1, the first direction d1 may be a column direction, and the second direction d2 may be a row direction.

The pixel unit 120A may include the plurality of pixels PX, which are arranged in a matrix. Each of the plurality of pixels PX may be connected to one of the data lines D1 through Dm and one of the scan lines S1 through Sn. Each of the plurality of pixels PX may be provided with a scan signal via one of the scan signals S1 through Sn connected thereto, and may be provided with a data signal via one of the data fines D1 through Dn connected thereto. The plurality of pixels PX may be connected to a first power source ELVDD via a first power line, and may be connected to a second power source ELVSS via a second power line. Each of the plurality of pixels PX may control the amount of current flowing from the first power source ELVDD to the second power source ELVSS according to the data signal provided thereto via one of the data lines D1 through Dn connected thereto.

The dummy pixel unit 120B may include the plurality of dummy pixels PX_D, which are located or arranged between the first power source ELVDD and the second power source ELVSS. The dummy pixel unit 120B may be located in an area of the display panel 120 that is not occupied by the pixel unit 120A. More specifically, the dummy pixel unit 120B may be arranged in the display panel 120 along the first direction d1, or may be arranged in the display panel 120 along the second direction d2, as illustrated in FIG. 1. In the example embodiment of FIG. 1, the first direction d1 may be a column direction, and the second direction d2 may be a row direction. There is nearly no restriction on the location of the dummy pixel unit 120B in the display panel 120 as long as the dummy pixel unit 120B can be provided in an area of the display panel 120 that is not occupied by the pixel unit 120A. Also, the dummy pixel unit 120B may be arranged in the display panel 120 to include at least one data line (in a case when the dummy pixel unit 120B is arranged along the first direction d1) or at least one scan line (in a case when the dummy pixel unit 120B is arranged along the second direction d2. In the description that follows, it is assumed that the dummy pixel unit 120B is connected to a first scan line S1 and is arranged in the display panel 120 along the second direction d2, as illustrated in FIG. 1.

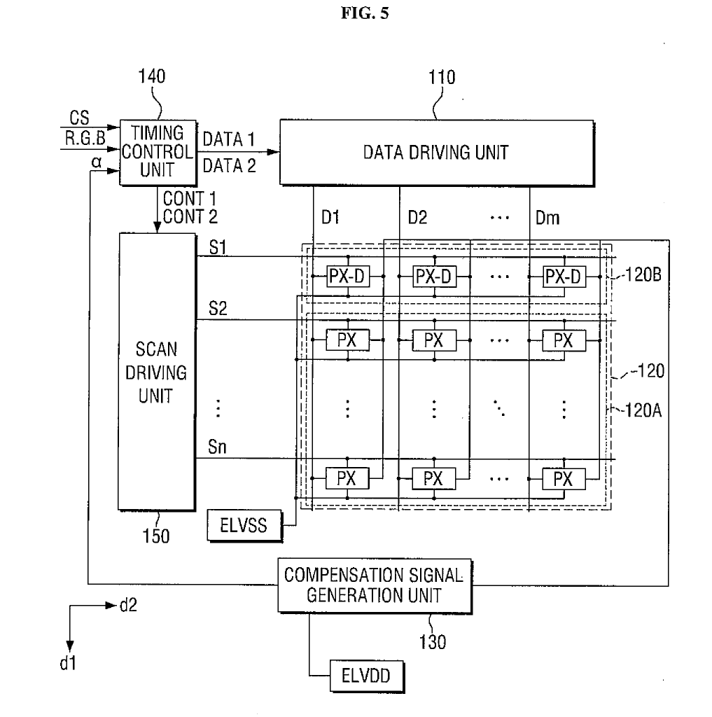

The compensation signal generation unit 130 may be located between the display panel 120 and the second power source ELVSS. Alternatively, the compensation signal generation unit 130 may be located between the display panel 120 and the first power source ELVDD, as illustrated in FIG. 5. The compensation signal generation unit 130 may measure the amount of current flowing in the pixel unit 120A and the amount of current flowing in the dummy pixel unit 120B. The compensation signal generation unit 130 may generate a compensation signal α by performing a comparison operation on the measured amounts of current, and may provide the compensation signal α to the timing control unit 140. The timing control unit 140 may receive the compensation signal α and may generate corrected image data DATA2 by correcting image data DATA1 based on the compensation signal α. The timing control unit 140 may provide the corrected image data DATA2 to the data driving unit 110. The data driving unit 110 may provide a data signal corresponding to the corrected image data DATA2 to the data lines D1 through Dm.

The timing control unit 140 may receive a control signal CS and an image signal “R, G, B” from an external system. The control signal CS may include a vertical synchronization signal Vsync and a horizontal synchronization signal Hsync. The image signal “R, G, B” may include luminance information relating to the plurality of pixels PX. Luminance may have, for example, 1024, 256 or 64 gray levels. The timing control unit 140 may generate the image data DATA1 by dividing the image signal “R, G, B” in units of frames according to the vertical synchronization signal Vsync and dividing the image signal “R, G, B” in units of the scan lines S1 through Sn according to the horizontal synchronization signal Hsync. The timing control unit 140 may provide control signals to the data driving unit 110, the scan driving unit 150 and a power supply unit based on the control signal CS and the image signal “R, G, B”. More specifically, the timing control unit 140 may provide the image data DATA1 to the data driving unit 110 together with a control signal, and the data driving unit 110 may convert the image data DATA1 into an analog voltage through sampling and holding according to the control signal provided thereto by the timing control unit 140, thereby generating a plurality of data signals. The data driving unit 110 may provide the plurality of data signals to the data lines D1 through Dm. In response to the compensation signal α being provided from the compensation signal generation unit 130, the timing control unit 140 may correct the image data DATA1 based on the compensation signal α, and may provide the corrected image data DATA2 to the data driving unit 110.

The scan driving unit 150 may be connected to the display panel 120 via the scan lines S1 through Sn. The timing control unit 140 may provide a driving control signal CONT1 to the scan driving unit 150 during a driving period and may provide a sensing control signal CONT2 to the scan driving unit 150 during a sensing period. In response to the driving control signal CONT1 being provided from the timing control unit 140, the scan driving unit 150 may sequentially apply a plurality of scan signals to the scan lines S1 through Sn. In response to the sensing control signal CONT2 being provided from the timing control unit 140, the scan driving unit 150 may apply a scan signal to a scan line connected to at least one pixel PX (among other pixels PX in the pixel unit 120A) that is to be measured for the amount of current flowing therein. For this, the scan driving unit 150 may include a shift register for sequentially applying a plurality of scan signals to the scan lines S1 through Sn according to the driving control signal CONT1, a sensing module for applying a scan signal to a scan line connected to at least one pixel PX that is to be measured for the amount of current flowing therein, and a switching circuit for selecting the shift register and the sensing module through a switching operation.

FIG. 2A is a circuit diagram of a pixel PXij according to an example embodiment of the invention. FIG. 2A illustrates the pixel PXij, which is located at the intersection between an i-th scan line Si and a j-th data line Dj, as an example, but the structure of the plurality of pixels PX is not limited to that set forth in FIG. 2A.

Referring to FIG. 2A, the pixel PXij may include a first switching transistor MS_1, a first driving transistor MD_1, a first capacitor C1 and an OLED “OLED”.

A control terminal of the first switching transistor MS_1 may be connected to the i-th scan line Si, and a first terminal of the first switching transistor MS_1 may be connected to the j-th data line Dj. A second terminal of the first switching transistor MS_1 may be connected to a control terminal of the first driving transistor MD_1. The first switching transistor MS_1 may selectively transmit a data signal provided thereto via the j-th data line Dj to the first driving transistor MD_1 through a switching operation according to a scan signal provided thereto via the i-th scan line Si.

A first terminal of the first capacitor C1 may be connected to the second terminal of the first switching transistor MS_1, and a second terminal of the first capacitor C1 may be connected to the first power source ELVDD. The first capacitor C1 may store therein the data signal provided thereto from the first switching transistor MS_1.

The control terminal of the first driving transistor MD_1 may be connected to the first switching transistor MS_1, and a first terminal of the first driving transistor MD_1 may be connected to the first power source ELVDD. A second terminal of the first driving transistor MD_1 may be connected to the second power source ELVSS via the OLED “OLED”. The first driving transistor MD_1 may control a driving current, which is provided from the first power source ELVDD to the second power source ELVSS via the OLED “OLED”, according to the data signal stored in the first capacitor C1. The OLED “OLED” may emit light according to the driving current.

FIG. 2B is a circuit diagram of a dummy pixel PX_Dij according to an example embodiment of the invention. FIG. 2B illustrates the dummy pixel PX_Dij, which is located at the intersection between the i-th scan line Si and the j-th data line Dj, as an example, but the structure of the plurality of dummy pixels PX_Dij is not limited to that set forth in FIG. 2B.

Referring to FIG. 2B, the dummy pixel PX_Dij may include a second switching transistor MS_2, a second driving transistor MD_2, a second capacitor C2 and a dummy OLED “OLED_D”.

A control terminal of the second switching transistor MS_2 may be connected to the i-th scan line Si, and a first terminal of the second switching transistor MS_2 may be connected to the j-th data line Dj. A second terminal of the second switching transistor MS_2 may be connected to a control terminal of the second driving transistor MD_2. The second switching transistor MS_2 may selectively transmit a data signal provided thereto via the j-th data line Dj to the second driving transistor MD_2 through a switching operation according to a scan signal provided thereto via the i-th scan line Si.

A first terminal of the second capacitor C2 may be connected to the second terminal of the second switching transistor MS_2, and a second terminal of the second capacitor C2 may be connected to the first power source ELVDD. The second capacitor C2 may store therein the data signal provided thereto from the second switching transistor MS_2.

The control terminal of the second driving transistor MD_2 may be connected to the second switching transistor MS_2, and a first terminal of the second driving transistor MD_2 may be connected to the first power source ELVDD. A second terminal of the second driving transistor MD_2 may be connected to the second power source ELVSS via the dummy OLED “OLED_D”. The second driving transistor MD_2 may control a driving current, which is provided from the first power source ELVDD to the second power source ELVSS via the dummy OLED “OLED_D”, according to the data signal stored in the second capacitor C2.

The dummy OLED “OLED_D” may not emit light during a driving period. Accordingly, the dummy OLED “OLED_D” may be replaced with a resistor that has the same resistance as the dummy OLED “OLED_D”.

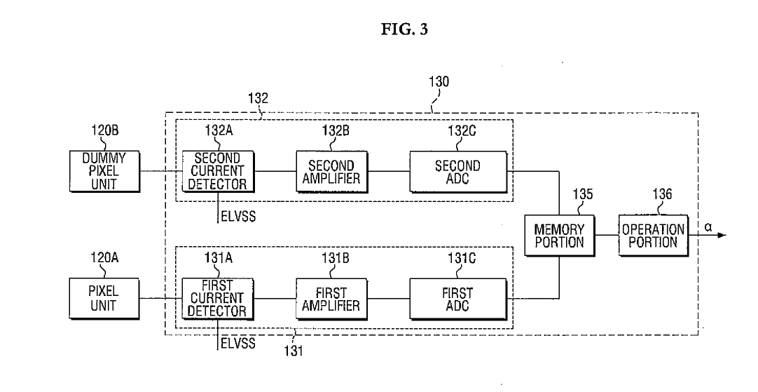

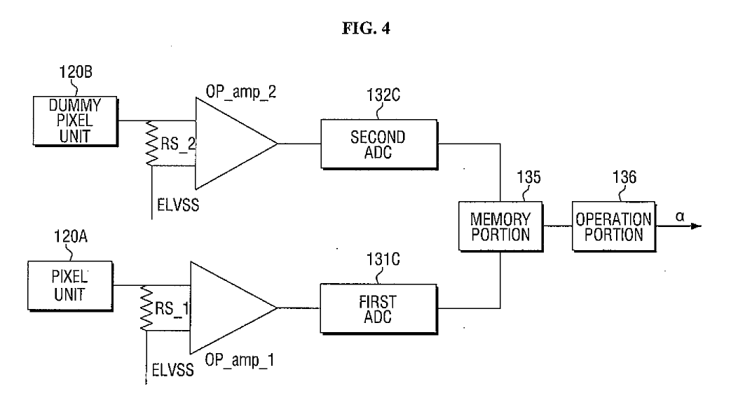

FIG. 3 is a block diagram of the compensation signal generation unit 130 according to the example embodiment of FIG. 1, and FIG. 4 is a circuit diagram of the compensation signal generation unit 130 illustrated in FIG. 3.

Referring to FIG. 3, the compensation signal generation unit 130 may include a first digital signal generation portion 131 (or a first digital signal generator), a second digital signal generation portion 132 (or a second digital signal generator), a memory portion 135 (or a memory) and an operation portion 136. The first digital signal generation portion 131 may measure the amount of current flowing from the pixel unit 120A to the second power source ELVSS, may convert a voltage corresponding to the measured amount of current into a digital signal, and may provide the digital signal to the operation portion 136. The second digital signal generation portion 132 may measure the amount of current flowing from the dummy pixel unit 120B to the second power source ELVSS, may convert a voltage corresponding to the measured amount of current into a digital signal, and may provide the digital signal to the memory portion 135. The operation portion 136 may generate the compensation signal α by performing a comparison operation based on the digital signal stored in the memory portion 135.

The first digital signal generation portion 131 may include a first current detector 131A, a first amplifier 131B, and a first analog-to-digital converter (ADC) 131C.

The first current detector 131A may receive a predetermined current from the pixel unit 120A, and a voltage corresponding to the predetermined current may be applied to the first current detector 131A. The first amplifier 131B may amplify the voltage applied to the first current detector 131A, and may provide the amplified voltage to the first ADC 131C. The first ADC 131C may convert the amplified voltage provided by the first amplifier 131B into a digital signal, and may provide the digital signal to the memory portion 135.

Referring to FIG. 4, the first current detector 131A may be a first sensing resistor RS_1, which is located between the pixel unit 120A and the second power source ELVSS. The first amplifier 131B may be a first operation amplifier OP_amp_1, which is connected to both ends of the first sensing resistor RS_1. That is, the first sensing resistor RS_1 may receive a predetermined current from the pixel unit 120A, and a voltage corresponding to the predetermined current may be applied to the first sensing resistor RS_1. The first operation amplifier OP-amp_1 may amplify the voltage applied to the first sensing resistor RS_1, and may provide the amplified voltage to the first ADC 131C. However, the first current detector 131A is not limited to the first sensing resistor RS_1. That is, a sample-and-hold circuit may be used to sample and hold the amount of current flowing in the pixel unit 120A and provide the sampled and held amount of current to the first ADC 131C. In some embodiments, the first digital signal generation portion 131 may also include a first control transistor, which is connected in parallel to the first sensing resistor RS_1. The first control transistor may be turned off during a sensing period, and may be turned on during the rest of the time. That is, during a sensing period, the first control transistor may be turned off so that a predetermined voltage may be applied to the first sensing resistor RS_1, and during a driving period, the first control transistor may be turned on so that an unnecessary consumption of power may be prevented.

Referring back to FIG. 3, the second digital signal generation portion 132 may include a second current detector 132A, a second amplifier 132B and a second ADC 132C.

The second current detector 132A may receive a current (e.g., a predetermined current) from the dummy pixel unit 120B, and a voltage corresponding to the current (e.g., the predetermined current) may be applied to the second current detector 132A. The second amplifier 132B may amplify the voltage applied to the second current detector 132A, and may provide the amplified voltage to the second ADC 132C. The second ADC 132C may convert the amplified voltage provided by the second amplifier 132B into a digital signal, and may provide the digital signal to the memory portion 135.

Referring again to FIG. 4, the second current detector 132A may be a second sensing resistor RS_2, which is located between the dummy pixel unit 120B and the second power source ELVSS. The second amplifier 132B may be a second operation amplifier OP_amp_2, which is connected to both ends of the second sensing resistor RS_2. That is, the second sensing resistor RS_2 may receive a predetermined current from the dummy pixel unit 120B, and a voltage corresponding to the predetermined current may be applied to the second sensing resistor RS_2. The second operation amplifier OP-amp_2 may amplify the voltage applied to the second sensing resistor RS_2, and may provide the amplified voltage to the second ADC 132C. However, the second current detector 132A is not limited to the second sensing resistor RS_2. That is, a sample-and-hold circuit may be used to sample and hold the amount of current flowing in the dummy pixel unit 120B and provide the sampled and held amount of current to the second ADC 132C.

FIG. 5 is a block diagram of an organic light-emitting display device according to another example embodiment of the invention.

Referring to FIG. 5, an organic light-emitting display device may include a data driving unit 110, a display panel 120 and a compensation signal generation unit 130. The organic light-emitting display device may also include a timing control unit 140 and a scan driving unit 150. For convenience, detailed descriptions of the elements of the organic light-emitting display device that are identical to their respective counterparts of FIGS. 1 to 4 will be omitted.

The compensation signal generation unit 130 may be located between the display panel 120 and a first power source ELVDD. The compensation signal generation unit 130 may measure the amount of current flowing from the first power source ELVDD to a pixel unit 120A and the amount of current flowing from the first power source ELVDD to a dummy pixel unit 120B. The compensation signal generation unit 130 may generate a compensation signal α by performing a comparison operation on the measured amounts of current, and may provide the compensation signal α to the timing control unit 140. The timing control unit 140 may receive the compensation signal α and may generate corrected image data DATA2 by correcting image data DATA1 based on the compensation signal α. The timing control unit 140 may provide the corrected image data DATA2 to the data driving unit 110. The data driving unit 110 may provide a data signal corresponding to the corrected image data DATA2 to the data lines D1 through Dm.

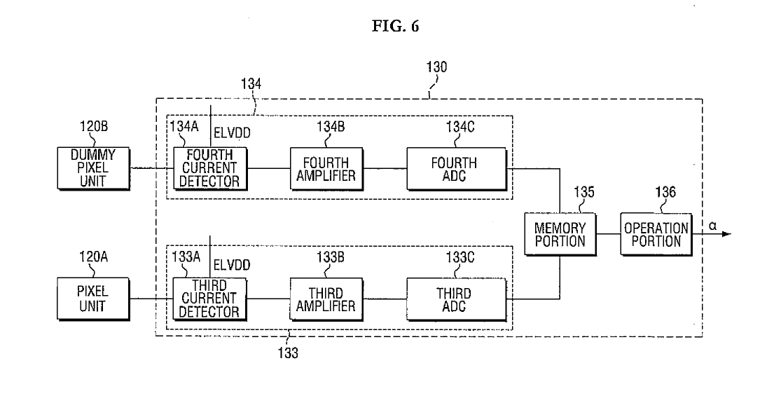

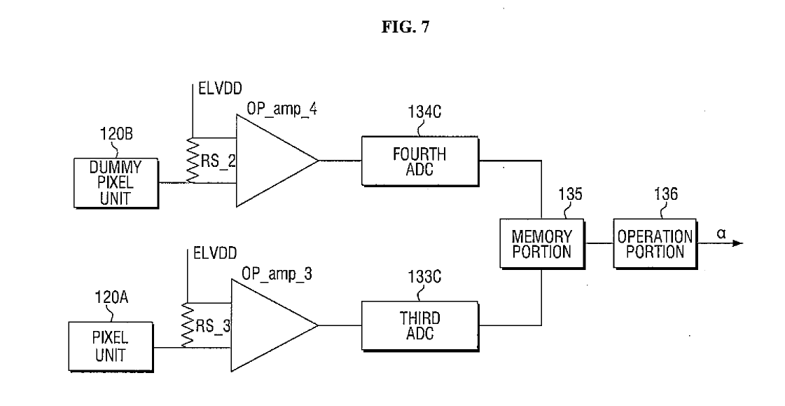

FIG. 6 is a block diagram of the compensation signal generation unit 130 according to the example embodiment of FIG. 5, and FIG. 7 is a circuit diagram of the compensation signal generation unit 130 illustrated in FIG. 6.

Referring to FIG. 6, the compensation signal generation unit 130 may include a first digital signal generation portion 133, a second digital signal generation portion 134, a memory portion 135, and an operation portion 136. The first digital signal generation portion 133 may measure the amount of current flowing from the first power source ELVDD to the pixel unit 120A, may convert a voltage corresponding to the measured amount of current into a digital signal, and may provide the digital signal to the operation portion 136. The second digital signal generation portion 134 may measure the amount of current flowing from the first power source ELVDD to the dummy pixel unit 120B, may convert a voltage corresponding to the measured amount of current into a digital signal, and may provide the digital signal to the memory portion 135. The operation portion 136 may generate the compensation signal α by performing a comparison operation based on the digital signal stored in the memory portion 135.

The first digital signal generation portion 133 may include a third current detector 133A, a third amplifier 1338, and a third ADC 133C.

A current (e.g., a predetermined current) may flow in the third current detector 133A due to the load of the pixel unit 120A, and a voltage corresponding to the current (e.g., the predetermined current) may be applied to the third current detector 133A. The third amplifier 133B may amplify the voltage applied to the third current detector 133A, and may provide the amplified voltage to the third ADC 133C. The third ADC 133C may convert the amplified voltage provided by the third amplifier 133B into a digital signal, and may provide the digital signal to the memory portion 135.

Referring to FIG. 7, the third current detector 133A may be a third sensing resistor RS_3, which is located between the first power source ELVDD and the pixel unit 120A. The third amplifier 133B may be a third operation amplifier OP_amp_3, which is connected to both ends of the third sensing resistor RS_3. That is, a current (e.g., a predetermined current) corresponding to the load of the pixel unit 120A may flow in the third sensing resistor RS_3, and a voltage corresponding to the current (e.g., the predetermined current) may be applied to the third sensing resistor RS_3. The third operation amplifier OP-amp_3 may amplify the voltage applied to the third sensing resistor RS_3, and may provide the amplified voltage to the third ADC 133C. However, the third current detector 133A is not limited to the third sensing resistor RS_3. That is, a sample-and-hold circuit may be used to sample and hold the amount of current flowing in the pixel unit 120A and provide the sampled and held amount of current to the third ADC 133C. In some embodiments, the first digital signal generation portion 133 may also include a second control transistor, which is connected in parallel to the third sensing resistor RS_3. The second control transistor may be turned off during a sensing period, and may be turned on during the rest of the time. That is, during a sensing period, the second control transistor may be turned off so that a predetermined voltage may be applied to the third sensing resistor RS_3, and during a driving period, the second control transistor may be turned on so that an unnecessary consumption of power may be prevented or reduced.

Referring back to FIG. 6, the second digital signal generation portion 134 may include a fourth current detector 134A, a fourth amplifier 134B and a fourth ADC 134C.

A current (e.g., a predetermined current) corresponding to the load of the dummy pixel unit 120B may flow in the fourth current detector 134A, and a voltage corresponding to the current (e.g., the predetermined current) may be applied to the fourth current detector 134A. The fourth amplifier 134B may amplify the voltage applied to the fourth current detector 134A, and may provide the amplified voltage to the fourth ADC 134C. The fourth ADC 134C may convert the amplified voltage provided by the fourth amplifier 134B into a digital signal, and may provide the digital signal to the memory portion 135.

Referring again to FIG. 7, the fourth current detector 134A may be a fourth sensing resistor RS_4, which is located between the dummy pixel unit 120B and the second power source ELVSS. The fourth amplifier 134B may be a fourth operation amplifier OP_amp_4, which is connected to both ends of the fourth sensing resistor RS_4. That is, a current (e.g., a predetermined current) corresponding to the load of the dummy pixel unit 120B may flow in the fourth sensing resistor RS_4, and a voltage corresponding to the current (e.g., the predetermined current) may be applied to the fourth sensing resistor RS_4. The fourth operation amplifier OP-amp_4 may amplify the voltage applied to the fourth sensing resistor RS_4, and may provide the amplified voltage to the fourth ADC 134C. However, the fourth current detector 134A is not limited to the fourth sensing resistor RS_4. That is, a sample-and-hold circuit may be used to sample and hold the amount of current flowing in the dummy pixel unit 120B and provide the sampled and held amount of current to the fourth ADC 134C.

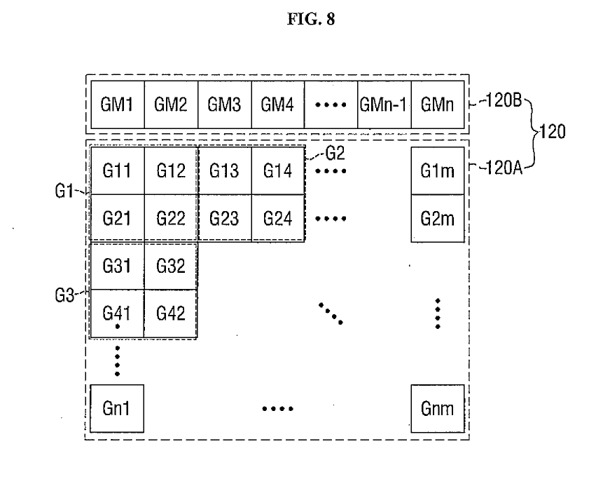

FIG. 8 is a schematic diagram illustrating the generation of a compensation signal by the compensation signal generation unit of FIG. 3 or 6, according to an example embodiment of the invention.

Referring to FIG. 8, the dummy pixel unit 120B may include a plurality of dummy pixel circuits GM1 through GMn, and the pixel unit 120A may include a plurality of pixel circuits G11 through Gnm. The operation portion 136 of FIG. 3 or 6 may divide the pixel unit 120A into a plurality of groups each having a predefined number of pixel circuits, and may obtain a first average value by averaging the current values of one or more pixel circuits included in each of the groups. The operation portion 136 may obtain a second average value by averaging the current values of the dummy pixel circuits GM1 through GMn. The operation portion 136 may generate a compensation signal α based on the first average value and the second average value, and may provide the compensation signal α to the timing control unit 140. For example, the average of the current values of one or more pixel circuits included in a group including the pixel circuit G11 may be the first average value, i.e., the first average value may be determined as the current value of the pixel circuit G11. The predefined number of pixel circuits included in each of the groups obtained by the operation portion 136 may be 1×1, 2×2, or 4×4. In response to each of the groups having for example, 2×2 pixel circuits as in FIG. 8, the average of the current values of four pixel circuits included in a first group G1 including the pixel circuit G11 (i.e., the average of the current values of the pixel circuits G11, G12, G21 and G22) may be determined as the current value of the pixel circuit G11. The current values of the pixel circuits G12, G21 and G22 may be calculated through linear interpolation based on the average current value of the first group G1, the average current value of a second group G2 including the pixel circuit G13, and the average current value of a third group G3 including a pixel circuit G31. Thereafter, the operation portion 136 may determine the degree of determination of each of the pixel circuits G11, G12, G21 and G22 by comparing each of the current values of the pixel circuits G11, G12, G21 and G22 included in the first group G1 with the second average value, may generate a compensation signal α for compensating for data corresponding to each of the pixel circuits G11, G12, G21 and G22, and may provide the compensation signal α to the timing control unit 140 of FIG. 1 or 5.

The timing control unit 140 may generate the corrected image data DATA2 by correcting the image data DATA1 based on the compensation signal α, and may provide the corrected image data DATA2 to the data driving unit 110. The data driving unit 110 may provide a data signal corresponding to the corrected image data DATA2 to one or more pixel circuits included in a particular part of the pixel unit 120A, for example, the pixel circuits G11, G12, G212 and G22 included in the first group G1.

A method of driving an organic light-emitting display device, according to an example embodiment of the invention, will hereinafter be described.

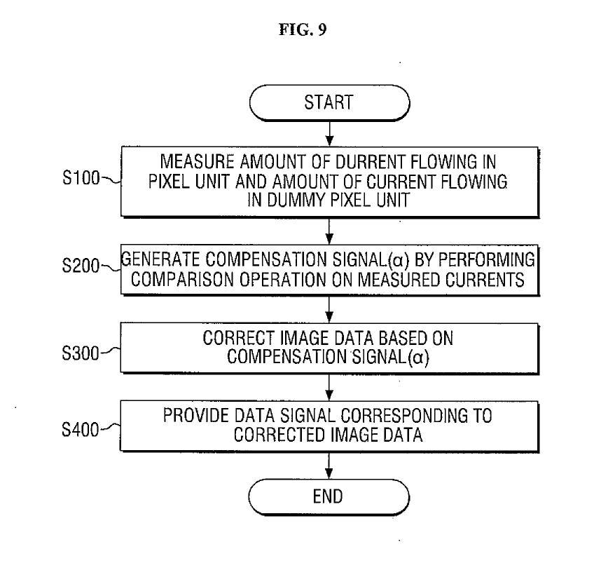

FIG. 9 is a flowchart illustrating a method of driving an organic light-emitting display device, according to an example embodiment of the invention. An organic light-emitting display device to which the method of FIG. 9 is applied may include a pixel unit 120A, which has an OLED “OLED” between a first power source ELVDD and a second power source ELVSS, and a dummy pixel unit 120B, which has a dummy OLED “OLED_D” between the first power source ELVDD and the second power source ELVSS, as illustrated in FIGS. 1 to 5. That is, the organic light-emitting display device to which the method of FIG. 9 is applied may be the organic light-emitting display device of FIGS. 1 to 5 or the organic light-emitting display device of FIGS. 6 to 8, and thus, a detailed description thereof will be omitted. In the description that follows, it is assumed that a compensation signal generation unit 130 is between a display panel 120 and the second power source ELVSS, as illustrated in FIGS. 1 to 4.

Referring to FIG. 9, the amount of current flowing in the pixel unit 120A and the amount of current flowing in the dummy pixel unit 120B may be measured (S100). More specifically, in response to a scan signal being applied to a scan line that is to be measured for the amount of current flowing therein during a sensing period, for example, a second scan line S2, the first switching transistors MS_1 of pixels PX that are connected to the second scan line S2 may be turned on. In response to a scan signal being applied to a first scan line S1, the second switching transistors MS_2 of dummy pixels PX_D that are connected to the first scan line S1 may be turned on. Thereafter, a data signal may be applied to a first data line D1, and the data signal may be provided to dummy pixels PX_D that are connected to the first data line D1 and the first scan line S1. The data signal may also be provided to pixels PX that are connected to the first data line D1 and the second scan line S2. Due to the data signal, a current (e.g., a predetermined current) may be applied to a first current detector 131A via an OLED “OLED”, and may also be applied to a second current detector 132A via a dummy OLED “OLED_D”. The first current detector 131A and the second current detector 132A may both be provided with a voltage corresponding to the predetermined current. A first amplifier 131B and a second amplifier 132B may amplify the voltage applied to the first current detector 131A and the voltage applied to the second current detector 132A, respectively, and may provide the amplified voltages, respectively, to a first ADC 131C and a second ADC 132C, respectively. The first ADC 131C and the second ADC 132C may convert the amplified voltages provided by the first amplifier 131B and the second amplifier 132B into digital signals, and may provide the digital signals to a memory portion 135. In the example embodiment of FIG. 9, the amount of current flowing in the pixel unit 120A and then the amount of current flowing in the dummy pixel unit 120B may be measured, but the order in which to measure the amount of current flowing in the pixel unit 120A and the amount of current flowing in the dummy pixel unit 120B is not limited to that set forth herein. That is, in an alternative example embodiment, the amount of current flowing in the pixel unit 120A and the amount of current flowing in the dummy pixel unit 120B may be measured at the same time.

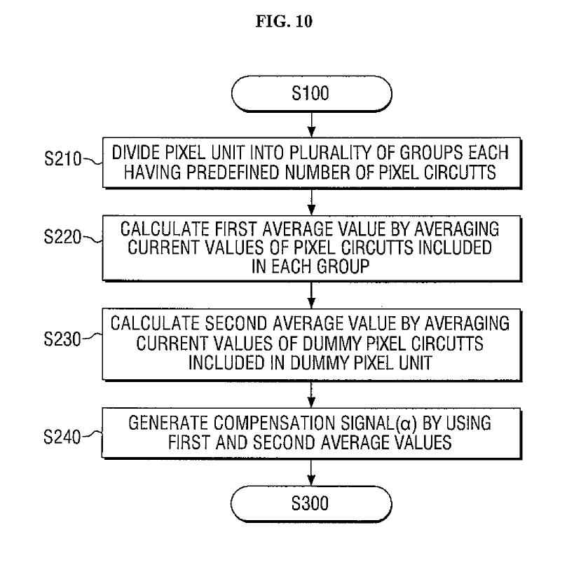

Thereafter, a compensation signal α may be generated by performing a comparison operation on the measured amounts of current (S200). FIG. 10 is a flowchart illustrating the generation of the compensation signal α as performed in the method of FIG. 9. Referring to FIGS. 9 and 10, the operation portion 136 may divide the pixel unit 120A into a plurality of groups each having a predefined number of pixel circuits (S210), and may calculate a first average value, which is the average of the current values of one or more pixel circuits included in each of the groups, based on a digital signal provided by the first ADC 131C (S220). The operation portion 136 may calculate a second average value by averaging the current values of a plurality of dummy pixel circuits included in the dummy pixel unit 120B (S230). Thereafter, the operation portion 136 may generate the compensation signal α by using the first average value and the second average value (S240). The generation of the compensation signal α with the use of the first average value and the second average value has already been described above with reference to FIG. 8, and thus, a detailed description thereof will be omitted. The order in which to perform the processes (S210 and S220) of calculating the first average value or the processes (S230 and S240) of calculating the second average value is not limited to that set forth in FIG. 10. For example, the processes (S210 and S220) of calculating the first average value or the processes (S230 and S240) of calculating the second average value may be performed at the same time.

Thereafter, the operation portion 136 may provide the compensation signal α to a timing control unit 140. The timing control unit 140 may generate corrected image data DATA2 (S300) by correcting image data DATA1 based on the compensation signal α, and may provide the corrected image data DATA2 to a data driving unit 110. The data driving unit 110 may provide a data signal corresponding to the corrected image data DATA2 to a plurality of pixel circuits included in part of the pixel unit 120A that needs to be corrected (S400).

The foregoing is illustrative of the present invention and is not to be construed as limiting thereof. Although a few embodiments of the present invention have been described, those skilled in the art will readily appreciate that many modifications are possible in the embodiments without materially departing from the novel teachings and advantages of the present invention. Accordingly, all such modifications are intended to be included within the scope of the present invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The present invention is defined by the following claims, with equivalents of the claims to be included therein.

What is claimed is:

1. An organic light-emitting display device, comprising:
a data driver configured to generate a data signal based on image data provided by a timing controller and to provide the data signal to a plurality of data lines;
a display panel comprising:
a pixel unit configured to control an amount of current flowing from a first power source to a second power source according to the data signal provided thereto via the plurality of data lines; and
a dummy pixel unit comprising a plurality of dummy pixel circuits configured to receive the data signal via the plurality of data lines; and
a compensation signal generator configured to generate a compensation signal by comparing an amount of current flowing in the pixel unit and an amount of current flowing in the dummy pixel unit.

2. The organic light-emitting display device of claim 1, wherein the timing controller is configured to receive the compensation signal from the compensation signal generator and to correct the image data based on the compensation signal.

3. The organic light-emitting display device of claim 1, wherein the compensation signal generator comprises:
a first digital signal generator configured to measure an amount of current flowing from the pixel unit to the second power source and to convert a voltage corresponding to the amount of current measured by the first digital signal generator into a first digital signal;
a second digital signal generator configured to measure an amount of current flowing from the dummy pixel unit to the second power source and to convert a voltage corresponding to the amount of current measured by the second digital signal generator into a second digital signal;
a memory configured to store the first digital signal and the second digital signal provided by the first digital signal generator and the second digital signal generator; and
an operation unit configured to generate the compensation signal by comparing the first digital signal and the second digital signal stored in the memory.

4. The organic light-emitting display device of claim 3, wherein the first digital signal generator comprises:
a first current detector configured to measure the amount of current flowing from the pixel unit to the second power source;
a first amplifier configured to amplify a voltage corresponding to the amount of current measured by the first current detector; and
a first analog-to-digital converter (ADC) configured to convert the amplified voltage provided by the first amplifier into a digital signal.

5. The organic light-emitting display device of claim 3, wherein the second digital signal generator comprises:
a second current detector configured to measure the amount of current flowing from the dummy pixel unit to the second power source;
a second amplifier configured to amplify a voltage corresponding to the amount of current measured by the second current detector; and
a second ADC configured to convert the amplified voltage provided by the second amplifier into a digital signal.

6. The organic light-emitting display device of claim 3, wherein the first digital signal generator comprises:
a third current detector configured to measure an amount of current flowing from the first power source to the pixel unit;
a third amplifier configured to amplify a voltage corresponding to the amount of current measured by the third current detector; and
a third ADC configured to convert the amplified voltage provided by the third amplifier into a digital signal.

7. The organic light-emitting display device of claim 3, wherein the second digital signal generator comprises:
a fourth current detector configured to measure an amount of current flowing from the first power source to the dummy pixel unit;
a fourth amplifier configured to amplify a voltage corresponding to the amount of current measured by the fourth current detector; and
a fourth ADC configured to convert the amplified voltage provided by the fourth amplifier into a digital signal.

8. The organic light-emitting display device of claim 3, wherein the operation unit is configured to divide the pixel unit into a plurality of groups each having a predefined number of pixel circuits, to calculate a first average value by averaging current values of one or more pixel circuits included in each of the groups, to calculate a second average value by averaging current values of the plurality of dummy pixel circuits, and to generate the compensation signal by using the first average value and the second average value.

9. An organic light-emitting display device, comprising:
a pixel unit comprising a first driving transistor, the first driving transistor comprising a first terminal connected to a first power source and a second terminal connected to a second power source via an organic light-emitting diode (OLED);
a dummy pixel unit comprising a second driving transistor, the second driving transistor comprising a first terminal connected to the first power source and a second terminal connected to the second power source; and
a compensation signal generator connected to the pixel unit and the dummy pixel unit and configured to generate a compensation signal by measuring an amount of current flowing in the pixel unit and an amount of current flowing in the dummy pixel unit and to perform an operation on the measured amounts of current.

10. The organic light-emitting display device of claim 9, further comprising:
a data driver connected to the pixel unit and the dummy pixel unit via a data line; and
a timing controller configured to receive the compensation signal from the compensation signal generator, correct image data based on the compensation signal, and provide a corrected image data to the data driving unit.

11. The organic light-emitting display device of claim 10, further comprising:
a scan driver connected to the pixel unit and the dummy pixel unit via a scan line,
wherein the timing controller is configured to provide a driving control signal to the scan driving unit during a driving period and to provide a sensing control signal to the scan driving unit during a sensing period.

12. The organic light-emitting display device of claim 10, wherein the pixel unit further comprises:
a first switching transistor comprising a first terminal connected to the data line and a second terminal connected to a control terminal of the first driving transistor; and
a first capacitor having a first terminal connected to the first terminal of the first driving transistor and a second terminal connected to the second terminal of the first switching transistor.

13. The organic light-emitting display device of claim 10, wherein the dummy pixel unit further comprises:
a second switching transistor having a first terminal connected to the data line and a second terminal connected to a control terminal of the second driving transistor; and
a second capacitor having a first terminal connected to the first terminal of the second driving transistor and a second terminal connected to the second terminal of the second switching transistor.

14. The organic light-emitting display device of claim 9, wherein the compensation signal generator includes:
a first current detector between the pixel unit and one of the first power source and the second power source;
a first amplifier connected to the first current detector and is configured to amplify a voltage applied to the first current detector;
a first ADC configured to convert the amplified voltage provided by the first amplifier into a digital signal;
a second current detector between the dummy pixel unit and one of the first power source and the second power source;
a second amplifier configured to amplify a voltage applied to the second current detector;
a second ADC configured to convert the amplified voltage provided by the second amplifier into a digital signal;
a memory configured to store the digital signal provided by the first ADC and the digital signal provided by the second ADC; and
an operation portion configured to generate the compensation signal by performing a comparison operation of the digital signals stored in the memory.

15. The organic light-emitting display device of claim 14, wherein the operation portion is configured to:
divide the pixel unit into a plurality of groups each having a predefined number, of pixel circuits;
calculate a first average value by averaging current values of one or more pixel circuits included in each of the groups;
calculate a second average value by averaging current values of a plurality of dummy pixel circuits; and
generate the compensation signal based on the first average value and the second average value.

16. A method of driving an organic light-emitting display device, the method comprising:
measuring an amount of current flowing in a pixel unit and an amount of current flowing in a dummy pixel unit;
generating a compensation signal by performing a comparison operation on the measured amounts of current;
correcting image data based on the compensation signal; and
providing a data signal corresponding to the corrected image data to the pixel unit.

17. The method of claim 16, wherein the measuring comprises:
measuring the amount of current flowing in the pixel unit;
amplifying a voltage corresponding to the measured amount of current flowing in the pixel unit; and
converting the amplified voltage into a digital signal.

18. The method of claim 16, wherein the measuring comprises:
measuring the amount of current flowing in the dummy pixel unit;
amplifying a voltage corresponding to the measured amount of current flowing in the dummy pixel unit; and
converting the amplified voltage into a digital signal.

19. The method of claim 16, wherein the generating comprises:
dividing the pixel unit into a plurality of groups each having a predefined number of pixel circuits; and
calculating a first average value by averaging current values of one or more pixel circuits included in each of the groups.

20. The method of claim 19, wherein the generating further comprises:
calculating a second average value by averaging current values of a plurality of dummy pixel circuits; and
generating the compensation signal based on the first average value and the second average value.
